(19) United States
(12) Patent Application Publication
(10) Pub. No.: US 2025/0061382 A1
(43) Pub. Date: Feb. 20, 2025

(54) SYSTEMS AND METHODS FOR MANAGING INTERACTION RECORDS BETWEEN AI AGENTS AND HUMAN EVALUATORS

(71) Applicant: AI REDEFINED INC., Montreal (CA)

(72) Inventor: François CHABOT, Brossard (CA)

(21) Appl. No.: 18/937,116

(22) Filed: Nov. 5, 2024

Related U.S. Application Data
(63) Continuation of application No. PCT/CA2023/050588, filed on May 1, 2023.
(60) Provisional application No. 63/339,070, filed on May 6, 2022.

(51) Int. Cl. G06N 20/00

(52) U.S. Cl. CPC G06N 20/00

(57) ABSTRACT

Systems and methods of training artificial intelligence (AI) agents for live Human-In-the-Loop Reinforcement Learning system are described. The systems and methods determine, among records of interaction between AI agents and human evaluators within a simulation environment, which of the records of interaction are either preserved or deleted, and on which location within a computer network the preserved records of interaction are stored. Storage available on the human user terminal is leveraged to store personalized datasets, freeing the generalization database to perform aggressive deduplication and decimation.

### CROSS-REFERENCE TO PREVIOUS APPLICATION

This application is a continuation of PCT/CA2023/050588 filed on May 1, 2023, which claims priority from U.S. provisional patent application No. 63/339,070 filed on May 6, 2022, each of which is incorporated herein by reference in its entirety.

### FIELD

The present disclosure relates generally to Human-In-the-Loop Learning (HILL), a branch of artificial intelligence (AI), with continuously learning AI agents taking actions alongside human evaluators. More specifically, the present disclosure relates to means for determining, among records of interaction between AI agents and human evaluators within a simulation environment, which of those records of interaction are either preserved or deleted, and on which location within a computer network those preserved records of interaction are stored.

### INTRODUCTION

The following paragraphs are provided by way of background to the present disclosure. They are not, however, an admission that anything discussed therein is prior art or part of the knowledge of persons skilled in the art.

Human-In-the-Loop Learning (HILL) of artificial intelligence (AI) agents covers various different methods and various roles for the human evaluators in the training loop. The management of records of interaction between human evaluators and AI learning agents is relevant for at least live HILL reinforcement learning (RL).

Performing HILL of AI agents on a large user population generates training data that scales linearly in size with the size of the user population. Training datasets can represent a large volume of data, in direct relation notably to variables such as the duration of the simulation, the number of learning agents' interventions, and the number of human interactions. For example, in contexts where an online video game is used as a simulation environment, such as in multiplayer online role-playing games, the dataset volume generated by any individual human user can represent several Megabits per minute.

In a training dataset, not all records are relevant. Many records are redundant across different users. Personalized training datasets, which are unique to a given user, are normally segregated from bulk training data before being usable. In certain contexts, it is advantageous to segregate from the bulk training data the records relevant to a given user, for example, to personalize the behavior of an AI agent with which the user might interact.

A typical HILL training session requires data to be transferred and analyzed on a centralized unit before any training dataset could be used. The accumulation of bulk training data on a centralized unit typically reaches data volumes that prevent the flexible and economical exploitation of such training data, given memory costs and bandwidth constraints.

Available systems do not provide for real-time identification, from bulk training data, of the non-relevant data that can be segregated, and the relevant data that can be stored for later use. Available systems also do not provide for segregation between relevant and non-relevant data, the recording of only relevant training data, the removal of non-relevant data from bulk training datasets, and the selection of storage on either local or centralized units.

There is a need to provide systems and methods for real-time (e.g., online) reinforcement learning that provide solutions to at least the above technical problems.

### SUMMARY

Various embodiments of a system and method for managing interaction records between AI agents and human evaluators, and computer products for use therewith, are provided according to the teachings herein.

According to one aspect of the present disclosure, there is provided a computer-implemented method for managing storage of reward records on a device of a human-in-the-loop learning system. The method comprises receiving a new record, the new record containing a state of an environment, an action taken by an agent in response to the state, and a reward generated by an evaluator. The method also comprises calculating a confidence score for the new record based at least in part on a likelihood that the reward contained in the new record was generated in response to the action contained in the new record. The method also comprises calculating a novelty score for the new record based at least in part on similarities between the new record and a plurality of similar stored records contained on a record storage of the device. Each of the plurality of similar stored records has an associated confidence score and an associated novelty score. The method also comprises determining whether an available storage capacity of the record storage is above a capacity threshold. The method also comprises storing the new record in the record storage of the device if the available storage capacity of the record storage is equal to or above the capacity threshold. The method also comprises replacing one of the plurality of similar stored records in the record storage with the new record if the available storage capacity of the record storage is below the capacity threshold, the confidence score of the new record is above the lowest confidence score associated with any of the plurality of similar stored records, and the novelty score of the new record is above a novelty threshold based on the novelty scores of the plurality of similar stored records.

In some examples, the method is repeated for a plurality of new records, each new record being received from a specific evaluator, and wherein the device is a local networked device forming part of the human-in-the-loop learning system and being associated with the specific evaluator.

In some examples, the method is repeated for a plurality of new records being associated with a plurality of evaluators, and wherein the device is a storage backend of the human-in-the-loop learning system.

In some examples, replacing one of the plurality of similar stored records further comprises replacing one of the plurality of similar stored records having the lowest confidence score.

In some examples, replacing one of the plurality of similar stored records further comprises replacing one of the plurality of similar stored records having the lowest novelty score.

In some examples, the confidence score is calculated using at least one of a co-occurrence of the reward contained in the new record and the action contained in the new record, a maximum class probability for the reward contained in the new record, a negative entropy of the reward contained in the new record, or a margin for the reward contained in the new record.

In some examples, the novelty score is calculated using at least one of a z-score for the new record compared to the plurality of similar stored records; an anomaly score for the new record using an isolation forest comprising the plurality of similar stored records, or a one-class SVM for the new record in relation to the plurality of similar stored records.

In some examples, the novelty threshold is calculated by at least one of a mean of previous novelty scores, some fraction of the mean of previous novelty score, the median of previous novelty score, some fraction of the median of previous novelty scores, some fraction of the maximum novelty score possible, or some fraction of the maximum novelty score to date.

In some examples, the similar stored records relate to a same portion of a learning session, records having a common state, records having a common action, or some combination thereof.

In some examples, the similar stored records relate to one another by at least one of a common state or a common action.

According to another aspect of the present disclosure, there is provided a system for managing storage of reward records on a device of a human-in-the-loop learning system. The system comprises a processor and a non-transitory computer-readable medium having store thereon instructions. When the instructions are executed by the processor, they cause the device to receive a new record, the new record containing a state of an environment, an action taken by an agent in response to the state, and a reward generated by an evaluator. When the instructions are executed by the processor, they also cause the device to calculate a confidence score for the new record based at least in part on a likelihood that the reward contained in the new record was generated in response to the action contained in the new record. When the instructions are executed by the processor, they also cause the device to calculate a novelty score for the new record based at least in part on similarities between the new record and a plurality of similar stored records contained on a record storage of the device, each of the plurality of similar stored records having an associated confidence score and an associated novelty score. When the instructions are executed by the processor, they also cause the device to determine whether an available storage capacity of the record storage is above a capacity threshold. When the instructions are executed by the processor, they also cause the device to store the new record in the record storage of the device if the available storage capacity of the record storage is equal to or above the capacity threshold. When the instructions are executed by the processor, they also cause the device to replace one of the plurality of similar stored records in the record storage with the new record if the available storage capacity of the record storage is below the capacity threshold, the confidence score of the new record is above the lowest confidence score associated with any of the plurality of similar stored records, and the novelty score of the new record is above a novelty threshold based on the novelty scores of the plurality of similar stored records.

In some examples, the device is further caused to repeat the aforementioned steps for a plurality of new records, each new record being received from a specific evaluator, and wherein the device is a local networked device forming part of the human-in-the-loop learning system and being associated with the specific evaluator.

In some examples, the device is further caused to repeat the aforementioned steps for a plurality of new records being associated with a plurality of evaluators, and wherein the device is a storage backend of the human-in-the-loop learning system.

In some examples, when the device is caused to replace one of the plurality of similar stored records, the device is further caused to replace one of the plurality of similar stored records having the lowest confidence score.

In some examples, when the device is caused to replace one of the plurality of similar stored records, the device is further caused to replace one of the plurality of similar stored records having the lowest novelty score.

In some examples, the confidence score is calculated using at least one of a co-occurrence of the reward contained in the new record and the action contained in the new record, a maximum class probability for the reward contained in the new record, a negative entropy of the reward contained in the new record, or a margin for the reward contained in the new record.

In some examples, the novelty score is calculated using at least one of a z-score for the new record compared to the plurality of similar stored records; an anomaly score for the new record using an isolation forest comprising the plurality of similar stored records, or a one-class SVM for the new record in relation to the plurality of similar stored records.

In some examples, the novelty threshold is calculated by at least one of a mean of previous novelty scores, some fraction of the mean of previous novelty score, the median of previous novelty score, some fraction of the median of previous novelty scores, some fraction of the maximum novelty score possible, or some fraction of the maximum novelty score to date.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein. In the drawings:

FIG. 1 shows a block diagram of an example embodiment of a system for managing interaction records between AI agents and human evaluators;

FIG. 2 shows a block diagram of an example embodiment of a computing device for use with the system of FIG. 1;

FIG. 3 shows a flowchart of an example embodiment of a method of generation, triage, segregation, and organization of training data;

FIG. 4 shows a flowchart of an example embodiment of a method of per-evaluator data decimation;

FIG. 5 shows a flowchart of an example embodiment of a method of global population data decimation; and

FIG. 6 shows a flowchart of an example embodiment of a method of data decimation for one or more records.

Further aspects and features of the example embodiments described herein will appear from the following description taken together with the accompanying drawings.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including at least one of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level procedural language such as object-oriented programming. The program code may be written in C⁺⁺, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

As used herein, the term “HILL” refers to Human-In-the-Loop learning. HILL encompasses multiple methods used to train AI agents while interacting with humans (e.g., human evaluators). Reinforcement Learning (RL) is a common approach for HILL, but other approaches such as Imitation Learning (IL) can be used as well. For the purposes of the embodiments described herein, the human may usually be considered to be an evaluator producing rewards.

As used herein, the term “agent” refers to a software-based artificial intelligence (AI) process that receives observations from an environment (simulated or not) and that decides to take actions within this environment. As used herein, the term “learning agent” refers to a specific kind of agent for which the AI process employs learning (e.g., RL).

As used herein, the term “policy” refers to the parametrized logic used by an agent to choose actions based on its observation of an environment and the agent's internal state.

As used herein, the term “environment” refers to a computer-generated environment and/or a real-world environment.

As used herein, the term “simulation” refers to a computer-generated environment which is configured to simulate one or more aspects of a real-world environment.

As used herein, the term “learning session” refers to a period of time during which agents interact with an environment and/or simulation in order to update their policies.

As used herein, the term “reward” refers to any information received by an agent from the environment, one or more other agents, and/or one or more human evaluators in response to the agent's performance of a task or action during a learning session. Rewards can include a numerical value representing the positive, negative, or neutral assessment of the task or action associated with the reward. Rewards can also include metadata associated with the rewards. Such metadata can include, but is not limited to, information relating to the entity sending or generating a reward and weighting information relating to a relative importance of a reward with respect to other rewards. As will be appreciated, metadata can also be used by agents to update their policies.

As used herein, the term “simulation backend” refers to a process responsible for updating the simulation state from the following components: (i) the previous simulation state; and (ii) one action among a list of possible agent actions per agent.

As used herein, the term “record” refers to a singular entry in a dataset comprised of a state, an action, and an optional reward. The “record” may be, for example, a datapoint.

As used herein, the term “dataset” refers to a list of historical records. The “dataset” may be, for example, a set of datapoints.

As used herein, the term “module” refers to a functional component that can generate useful data or other output using specified input(s). A module may or may not be self-contained. A computer program (also called an “application”) may include one or more modules, and a module can include one or more computer programs. A module can be implemented by software, hardware, or firmware components, or any combination thereof.

As used herein, the term “novelty” refers to a measure of the quantity of new information provided by a record over existing data. A “novelty score” for a particular record may be calculated based on the novelty of that record.

As used herein, the term “confidence” refers to a measure of the likelihood that a reward was generated in response to an action. A “confidence score” for a particular record may be calculated based on the confidence that the reward contained in that record was generated in response to the action contained in that record.

As used herein, the term “state” refers to the set of properties that describe the state of the simulation environment at a given point in time.

As used herein, the term “user” refers to an individual human user. In some embodiments, where the “user” provides evaluations, the “user” may alternatively be referred to as an “evaluator”.

In accordance with the teachings herein, there are provided various embodiments for systems and methods for managing interaction records between AI agents and human evaluators, and computer products for use therewith. The methods and systems may be implemented in a simulation environment available to a plurality of individual human evaluators.

The embodiments described herein provide technical solutions for various technical problems. One such technical problem is the effective triage, segregation, and organization of training data, in real time or in deferred time, to enable systematic segregation of agent records of interaction.

Another technical problem is effectively determining, among records of interaction between agents and human evaluators within a simulation environment, which of those records of interaction are to be preserved or deleted.

Another technical problem is the effective creation of personalized datasets for each human evaluator or interaction.

Another technical problem is the effective determination, among the preserved records of interaction between agents and human evaluators, the location within a computer network where those preserved records of interaction are to be stored.

Another technical problem is the effective storage of datasets on local terminals.

Another technical problem is effectively freeing general-purpose database use. Another technical problem is efficiently deduplicating datasets on a general-purpose database selectively decimating those datasets, within a network of a remotely accessible simulation environment.

Another technical problem is efficiently using available memory to achieve faster access and reduced memory space requirements on local terminals and centralized units.

At least one embodiment of the methods and systems described in accordance with the teachings herein provides technical solutions to one or more of the aforementioned technical problems. One such embodiment is a computer-implemented system for managing interaction records between agents and human evaluators. The system includes a centralized unit connecting to a plurality of local terminals, a simulation environment, a plurality of agents which can affect the simulation environment based on user interaction with the simulation environment, and a dataset comprising the interaction records.

A non-limiting example of the computer-implemented method includes performing, by a hardware processor, the act of locally calculating a confidence score, wherein at least one of the interaction records equal to or above a predetermined threshold is stored on the memory means of the local terminal. The method further includes performing, by a hardware processor, the act of locally calculating a novelty score, wherein at least one of the interaction records which is below a predetermined confidence score threshold and equal to or above a predetermined novelty score threshold is stored on the memory means of the centralized unit, and wherein at least one of the interaction records which is below a predetermined novelty score is deleted.

At least one embodiment of the methods described in accordance with the teachings herein provides technical solutions to one or more of the aforementioned technical problems. One such embodiment is a computer-implemented method for managing interaction records between agents and human users. A non-limiting example of the computer-implemented method includes calculating, for each historical agent action, a confidence score. If the confidence score is equal to or above a predetermined threshold, then a corresponding interaction record from amongst the interaction records is stored on the local terminal. If the confidence score is below a predetermined threshold, then a novelty score is calculated. If the novelty score is equal to or above a predetermined threshold, then the corresponding interaction record is stored on a centralized database. In addition, or optionally, if the confidence score is below a predetermined threshold, then the corresponding interaction record is deleted.

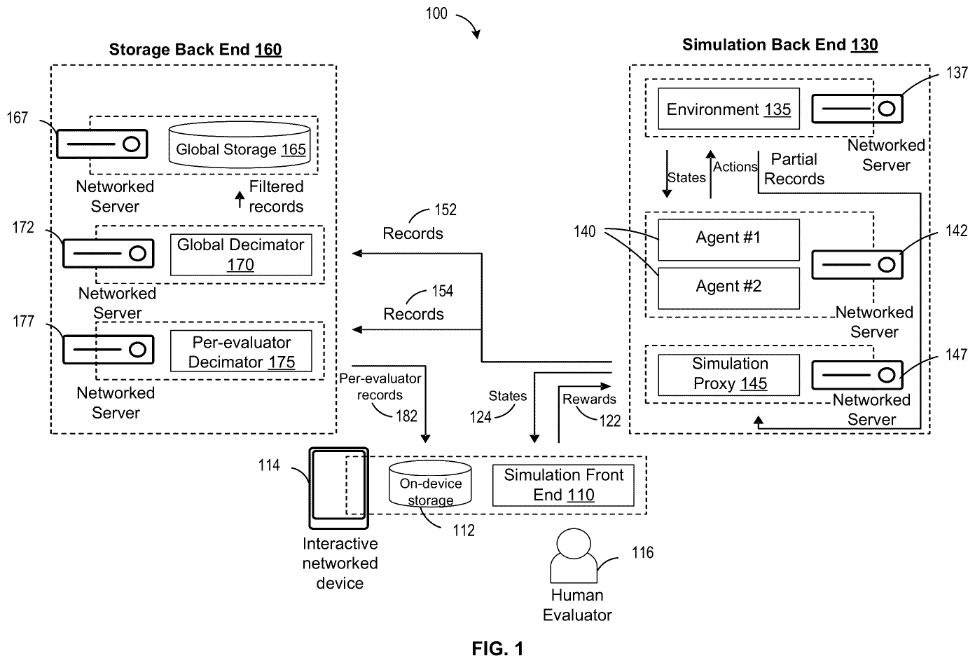

Reference is first made to FIG. 1, showing an example embodiment of a of a system 100 for managing interaction records between AI agents and human users. The system 100 includes a simulation front end 110, a simulation back end 130, and a storage back end 160.

The simulation front end 110 includes a computing device with an interface that allows a human evaluator 116 to access and/or communicate with other parts of the system 100. The simulation front end 119 may have on-device storage 112, which may store data entered in by the human evaluator 116 or received from other parts of the system 100. The computing device of the simulation front end 110 may be an interactive networked device 114.

The simulation back end 130 includes a simulation environment 135, one or more agents 140, and a simulation proxy 145. The simulation back end 130 may include networked servers 137, 142, 147, that communicate with each other and/or communicate with other parts of the system 100. The simulation environment 135 may be run by the networked server 137. The one or more agents 140 may be run by the networked server 142. The simulation proxy 145 may be run by the networked server 147.

The storage back end 160 includes global storage 165, a global decimator 170, and a per-evaluator decimator 175. The storage back end 160 may include networked servers 167, 172, 177, that communicate with each other and/or communicate with other parts of the system 100. The global storage 165 may be run by the networked server 167. The global decimator 170 may be run by the networked server 172. The per-evaluator decimator 175 may be run by the networked server.

The simulation front end 110 is configured to send rewards 122 to the simulation proxy 145. The simulation front end 110 is configured to receive states 124 from the simulation proxy 145 and process the states 124. The simulation front end 110 is configured to receive per-evaluator records 182 from the per-evaluator decimator 175 and process the per-evaluator records 182.

The simulation environment 135 is configured to send states to the one or more agents 140. The simulation environment is configured to receive actions from the one or more agents 140 and process those actions. The simulation environment 135 is configured to send partial records to the simulation proxy 145.

The one or more agents 140 is configured to send actions to the simulation environment 135. The one or more agents 140 is configured to receive states from the simulation environment 135 and process those states.

The simulation proxy 145 is configured to receive partial records from the simulation environment 135 and process those partial records. The simulation proxy 145 is configured to receive the rewards 122 from the simulation front end 110 and process the rewards 122. The simulation proxy 145 is configured to send the states 124 to the simulation front end 110. The simulation proxy 145 is configured to send records 152 to the global decimator 170 and send records 154 to the per-evaluator decimator 175.

The global storage 165 is configured to receive filtered records from the global decimator 170 and process those filtered records.

The global decimator 170 is configured to receive the records 152 from the simulation proxy 145 and process the records 152. The global decimator 170 is configured to send filtered records to the global storage 165.

The per-evaluator decimator 175 is configured to receive the records 154 from the simulation proxy 145 and process the records 154. The per-evaluator decimator 175 is configured to send the per-evaluator records 182 to the simulation front end 110.

By way of example, the data flow in system 100 may occur as follows. The simulation environment 135 sends a state to an agent 140. The agent 140 sends an action to the simulation environment 135. The environment 135 sends a partial record to the simulation proxy 145. The simulation proxy 145 sends the state (as state 124) to the simulation front end 110. The simulation front end 110 sends a reward 122 to the simulation proxy 145. The simulation proxy 145 sends a first record (as record 152) to the global decimator 170 and a second record (as record 154) to the per-evaluator decimator 175. The global decimator 170 filters the first record and sends that to the global storage 165. The per-evaluator decimator 175 sends the second record (as a per-evaluator record 182) to the simulation front end 110.

The various elements of the system 100 can be interconnected using any suitable wired or wireless data communication means and may be provided through the use of dedicated hardware as well as hardware capable of executing software in association with appropriate software. The distributed system 100 may also include one or more communication components (not shown) configured to allow the system 100 to communicate with a data communications network such as the Internet, and communication thereto/therefrom can be provided over a wired connection and/or a wireless connection.

In particular, each of the simulation front end 110, the simulation back end 130, and the storage back end 160 may be networked computers connecting remotely to one another and installed with computational means comprising a hardware processor, memory, optional input/output devices, and data communications means. For example, and without limitation, each of the simulation front end 110, the simulation back end 130, and the storage back end 160 may be a programmable logic unit, a mainframe computer, a server, a personal computer, or a cloud-based program or system. The interactive networked device 114 may be a personal computer, a smartphone, a smart watch, or a tablet device, or any combination of the foregoing.

The aforementioned hardware processors may be implemented in hardware or software, or a combination of both. They may be implemented on a programmable processing device, such as a microprocessor or microcontroller, a Central Processing Unit (CPU), a Digital Signal Processor (DSP), a Field Programmable Gate Array (FPGA), general purpose processor, and the like. The hardware processors can be coupled to memory means, which store instructions used to execute software programs. Memory can include non-transitory storage media, both volatile and non-volatile, including but not limited to, random access memory (RAM), dynamic random-access memory (DRAM), static random-access memory (SRAM), read-only memory (ROM), programmable read-only memory (PROM), erasable programmable read-only memory (EPROM), electrically erasable programmable read-only memory (EEPROM), flash memory, magnetic media, or optical media. Communications means can include a wireless radio communication modem such as a Wi-Fi modem and/or means to connect to a local area network (LAN) or a wide area network (WAN).

The simulation front end 110, the simulation back end 130, and the storage back end 160 can be located remotely and in data communication via, for example, the Internet, or located proximally and in data communication via, for example, a LAN. The simulation front end 110, the simulation back end 130, and the storage back end 160 can connect to a proxy server remotely or locally. In some embodiments, the simulation front end 110, the simulation back end 130, and the storage back end 160 can be implemented, for example, in a cloud-based computing environment, by virtual machines or containers, or by a single computer or a group of computers. In some embodiments, the system 100, as well as any software applications and data related thereto, can be distributed between the simulation front end 110, the simulation back end 130, and the storage back end 160, for example, using a cloud-based distribution platform.

The system 100 can be implemented by computer programs that provide a simulated environment characterized by an interface between a user, or a user and an agent, and the system to be experimentally studied, and which performs tasks including description, modeling, experimentation, knowledge handling, evaluating, and reporting. The system 100 may be the manifestation of the situation in which agents are to accomplish a task and includes all of the logical relationships and rules required to resolve how the agents and the environment can interact. The system 100 may provide states, which are representations of a state at a certain time step within the environment. Such states can be perceived by agents through sensors or may be directly provided by the environment. An agent can perceive a state, or part thereof, and form an observation thereon. An observation can therefore be in respect to a simulation, task, procedure, event, or part thereof, and may be specific to an agent's perspective on a state of an environment. The agents may be configured to produce actions in response to observations and are presented with rewards according to the impact those actions have or had on the environment and/or on other agents.

Each software application may be implemented in a high-level procedural or object-oriented programming and/or scripting language to communicate with a computer system. Alternatively, the software applications can be implemented in assembly or machine language, if desired. In either case, language may be a compiled or interpreted language. Each such software application on the system 100 (or any part thereof) may be stored on memory means and readable by a hardware processor for configuring and operating the system 100 when memory is read by the hardware processor to perform the procedures described herein.

In at least one embodiment, the simulation environment 135 is configured to send states to the one or more agents 140 and to receive actions from the one or more agents 140. Tasks performed by a first agent from among the one or more agents 140 can be evaluated by the simulation environment 135, by one or more other agents from among the one or more agents 140, and/or by one or more human evaluators (such as human evaluator 116). Each of the simulation environments 135, one or more agents 140, and/or one or more human evaluators 116 can generate and provide the first agent with appropriate rewards based on their respective evaluations. Each reward can refer to an action performed by the one or more agents 140 either in real-time or in the past. In particular, human evaluators (such as human evaluator 116) have the capacity to attribute rewards relating to the performance by one of the one or more agents 140 of past actions. The simulation environment 135 may thus evolve over time as a result of sequential states, observations, and actions of the one or more agents 140.

The simulation environment 135 may be implemented either online or offline. In some embodiments, the simulation proxy 145 can be implemented in such a way as to collect rewards during a learning session and provide the rewards to the one or more agents 140 once the learning session has ended (i.e., an offline implementation). Alternatively, or in addition, the simulation proxy 145 can be implemented in such a way as to collect and send rewards to the one or more agents 140 during a learning session (i.e., an online, or real-time, implementation). In some embodiments, the simulation proxy 145 is configured to collect, aggregate, and send rewards to the one or more agents 140.

In at least one embodiment, the simulation proxy 145 manages the flow of rewards between each of the networked server 142 (of the one or more agents 140) and the interactive networked device 114 (of the simulation front end 110). In particular, the simulation proxy 145 receives rewards from the interactive networked device 114, each controlled by a human evaluator 115, and transmits rewards to the one or more agents 140. The simulation proxy 145 also provides reward and learning process information to the networked server 172 (of the global decimator 170) for storage on the networked server 167 (of the global storage 165). In some embodiments, learning process records can include, but are not necessarily limited to, agent state information, agent action information, and agent reward information.

The human evaluators 116 may be provided with access to the simulation environment 135 by way of the interactive networked device 114. The simulation environment 135 may be updated either in real time on a continuous basis, or using a calendar or event-based process, such events including, but not limited to, the end of a learning session or the start of a new learning session.

In at least one embodiment, the simulation environment 135 can implement a flight simulation environment in which the one or more agents 140 train to pilot a drone, where one or more tasks assigned to the one or more agents 140 is to determine the location of forest fires in the simulation. In the example, the human evaluator 116 can also pilot a helicopter simulation with a view to accomplishing the same task. The simulation environment 135 can provide rewards to agents relating to how well the one or more agents 140 and human evaluator 116 pairings are performing.

The simulation environment 135 creates a high volume of data in real time, and the system 100 sends reward information to the one or more agents 140 as it is being generated, in order for the one or more agents 140 to learn to pilot the drone and to perform the task as quickly as possible. The human evaluator 116 (who may be well trained in the task), can provide expert knowledge to the system 100 by providing rewards to the one or more agents 140 based on the performance of the one or more agents 140 at performing specific actions. As such, the one or more agents 140 can receive rewards from the human evaluators 116, via the interactive networked device 114 and the simulation proxy 145. In the present example, the human evaluator 116 rewards can take various forms, including without limitation, the human evaluator 116 providing positive or negative rewards in response to a flight path, elevation, speed, or direction of the drone piloted by the one or more agents 140. Integration of rewards received from the human evaluator 116 in the learning process accelerates the speed at which the one or more agents 140 identify actions having positive outcomes (i.e., receiving rewards), and thus accelerates the learning speed of the one or more agents 140.

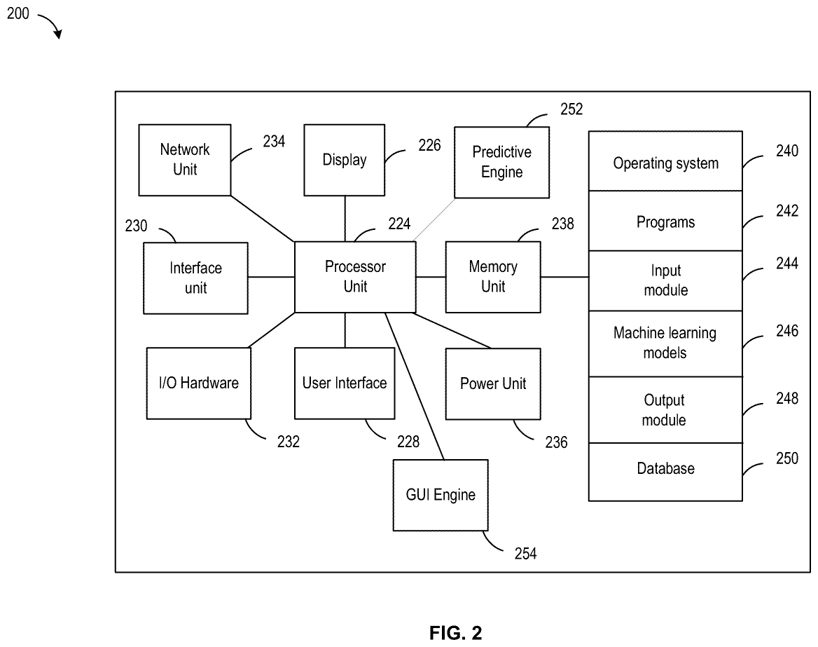

Referring now to FIG. 2, shown therein is a block diagram of an example embodiment of a computing device 200 for use with the system 100. One or more of the interactive networked device 114, the networked servers 137, 142, 147 (in the simulation back end 130), and/or the networked servers 167, 172, 177 (in the storage back end 160) may be embodied by the computing device 200 as described below.

The computing device 200 may run on a single computer, including a processor unit 224, a display 226, a user interface 228, an interface unit 230, input/output (I/O) hardware 232, a network unit 234, a power unit 236, and a memory unit (also referred to as “data store”) 238. In other embodiments, the computing device 200 may have more or less components but generally function in a similar manner. For example, the computing device 200 may be implemented using more than one computing device.

The processor unit 224 may include a standard processor, such as the Xeon® processor sold by Intel Corporation®, for example. Alternatively, there may be a plurality of processors that are used by the processor unit 224, and these processors may function in parallel and perform certain functions. The display 226 may be, but not limited to, a computer monitor or an LCD display such as that for a tablet device. The user interface 228 may be an Application Programming Interface (API) or a web-based application that is accessible via the network unit 234. The network unit 234 may be a standard network adapter such as an Ethernet or 802.11x adapter.

The processor unit 224 may execute a predictive engine 252 that functions to provide predictions by using machine learning models 246 stored in the memory unit 238. The predictive engine 252 may build a predictive algorithm through machine learning. The training data may include, for example, image data, video data, audio data, and text.

The processor unit 224 can also execute a graphical user interface (GUI) engine 254 that is used to generate various GUIs. The GUI engine 254 provides data according to a certain layout for each user interface and also receives data input or control inputs from a user. The GUI then uses the inputs from the user to change the data that is shown on the current user interface, or changes the operation of the computing device 200 which may include showing a different user interface.

The memory unit 238 may store the program instructions for an operating system 240, program code 242 for other applications, an input module 244, a plurality of machine learning models 246, an output module 248, and a database 250. The machine learning models 246 may include, but are not limited to, image recognition and categorization algorithms based on deep learning models and other approaches. The database 250 may be, for example, a local database, an external database, a database on the cloud, multiple databases, or a combination thereof.

In at least one embodiment, the machine learning models 246 include a combination of convolutional and recurrent neural networks. Convolutional neural networks (CNNs) are designed to recognize images, patterns. CNNs perform convolution operations, which, for example, can be used to classify regions of an image, and see the edges of an object recognized in the image regions. Recurrent neural networks (RNNs) can be used to recognize sequences, such as text, speech, and temporal evolution, and therefore RNNs can be applied to a sequence of data to predict what will occur next. Accordingly, a CNN may be used to read what is happening on a given image at a given time, while an RNN can be used to provide an informational message.

The programs 242 comprise program code that, when executed, configures the processor unit 224 to operate in a particular manner to implement various functions and tools for the computing device 200.

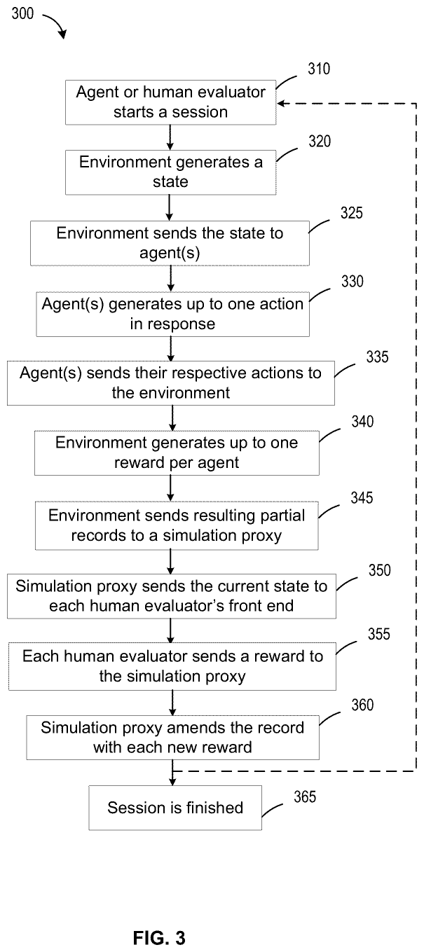

Referring now to FIG. 3, shown therein is a flowchart of an example embodiment of a method 300 of generation, triage, segregation, and organization of training data. The method 300 may be used by the system 100.

At 310, an agent (e.g., one of the one or more agents 140) or a human evaluator (e.g., human evaluator 116) starts a session.

At 320, an environment (e.g., simulation environment 135) generates a state. For example, the environment obtains the state from a physical or virtual perception device. For example, the state is a representation of a state at a certain time step within the environment.

At 325, the environment sends the state to one or more agents.

At 330, each of the one or more agents generates up to one action in response. For example, the one or more agents can perceive a state, or part thereof, and form an action thereon. An action can therefore be in respect to a simulation, task, procedure, event, or part thereof, and may be specific to an agent's perspective on a state of the environment.

At 335, each of the one or more agents sends their respective actions to the environment.

At 340, the environment generates up to one reward per agent. For example, each of the agents may be presented with a reward according to the impact those actions have or had on the environment and/or on other agents.

At 345, the environment sends resulting partial records, resulting from the generation of rewards, to a simulation proxy (e.g., simulation proxy 145).

At 350, the simulation proxy sends the current state, extracted from the latest record to each human evaluator's front end.

At 355, each human evaluator sends a reward to the simulation proxy.

At 360, the simulation proxy amends the record with each new reward. This may happen later, in which case the simulation proxy may be programmed to deal with the delay.

At 365, the environment returns to 310, unless the session is finished.

During method 300, in parallel regularly and/or at the end of the session, the environment may send the records to the storage back end, both to the pre-evaluator and the global decimator.

Method 300 contemplates setups where a large number of human evaluators assess the performance of AI agents, which may take the form of AI agents taking part in a competitive game, such as hide and seek. In this context, the environment may centralize the rewards generated by all of the human evaluators to leverage the “wisdom of crowd” to train the best hide and seek policy. The environment may train a specific hide and seek policy by excluding the rewards provided by all but one human evaluator to leverage specific expertise in the field or to create a per evaluator policy.

Those use cases create a set of technical concerns. First, the data generated by the human evaluators can grow to a very significant amount causing storage issues. Second, it can be expected that a lot of the generated data will be redundant, limiting the efficiency of the storage and causing potential biases in the usage of the data. Third, retaining the ability to segregate the rewards provided by a specific human evaluator to train per evaluator policy requires the storage of additional data and limits the ability to aggressively remove redundant records.

To address these technical concerns, a system for managing interaction records between AI agents and human users can employ one or more methods of data decimation—per-user data decimation and global population data decimation.

In either method of data decimation, records are stored in two different locations: (1) a global storage which stores records including rewards from all evaluations, and (2) a per-evaluator on-device storage which stores records excluding rewards provided by other human evaluators. The methods of data decimation may enforce an upper bound on the stored data in both locations using two scores to decide if each record is stored on-device, globally, both, or neither.

The first score is called confidence, which in some embodiments is an estimate of how much a reward is causally linked to the success of the task. Records having a low confidence are less relevant (i.e., less causally linked) to the success of a task and are more likely to not be stored. Confidence can be estimated in different ways, including by the human evaluator themself.

For example, a drone can provide feedback from the last 30 seconds, such as acceleration. A human evaluator can pinpoint a specific location and provide feedback of what the drone did, such as whether it was linked to the success of the task. The data can be two-dimensional, the first being the reward itself (e.g., negative to positive) and the second being the confidence.

Feedback may be provided automatically. For example, the human evaluator may be unable to pinpoint an exact location. The system can expand the location of the reward. The human evaluator may say that at a particular point, something good or bad happened. The event may have occurred a number of frames prior to that. The system can distribute the allocation of the reward over a longer timeframe.

For example, suppose a drone turns to the right and the human evaluator says that was a good action. The system can assign a positive evaluation of other nearby actions (e.g., other frames).

Determining confidence may be based on statistical significance. For example, if the drone has a choice of taking three actions (e.g., go forward, turn right, turn left), the model can give more weight to actions that statistically are more significant (e.g., turn right, turn left). These actions can be identified by a model for that particular task. Confidence can be absolute, calculated for the particular data record at issue. For example, suppose a model is trained on historical data to evaluate the co-occurrence of a type of action and a reward event; this co-occurrence factor can be used as a confidence score (e.g., when a left turn left and reward usually co-occur equates to a high score).

The second score is called novelty, which in some embodiments is an estimate of how much new information the record brings relative to existing data in storage. Records having a low novelty are less relevant and are more likely to not be stored. Novelty can be estimated in different ways, including by using a distance measurement between the new record and the closest existing neighbors.

For example, when the data is identified as having high novelty, it can affect whether it is being stored and where it is stored. The decimation processes, per-evaluator and global, arrive at different scores independently.

For example, the system looks at the record at issue and how it compares to the distribution. Suppose the possible actions are to go forward, turn right, or turn left. The record includes the possible actions and the reward (evaluated by the human evaluator). The system may look at the position of the drone, as well as whether the evaluation is highly positive or highly negative in that instance for that human evaluator, or also whether multiple evaluators have agreed on the particular evaluation.

For example, if the drone is engaged in repetitive actions and the evaluator gives the same rewards in similar locations with similar rewards, then the novelty is very low.

The evaluation of the novelty score is related to the field of novelty detection that is used in machine learning and data science. Novelty is relative, determined by the relevance of the record to a particular user. For example, the novelty score can be one or more of (or can be derived from) a z-score, an anomaly score using an isolation forest, or a One-Class Classification (OCC) Support Vector Machine (SVM), for example.

A z-score is a numerical measurement that describes a value's relationship to the mean (i.e., standard deviations from the mean) of a group of values. Isolation forest is an anomaly detection algorithm that detects anomalies using isolation (how far a data point is to the rest of the data). A One-Class Classification (OCC) Support Vector Machine (SVM) is an algorithm that seeks to identify objects of a specific class amongst all objects by learning from a training set containing only the objects of the specific class.

With regards to storage, the system can have both global and local storage. The system trains the method of storing based on the quantity of storage available. (1) It can be based on limiting central storage. (2) It can be based on whether the data is more appropriate to be stored locally rather than globally (e.g., when the data is more relevant to a particular user). When the system stores data locally, it can be analyzed more quickly.

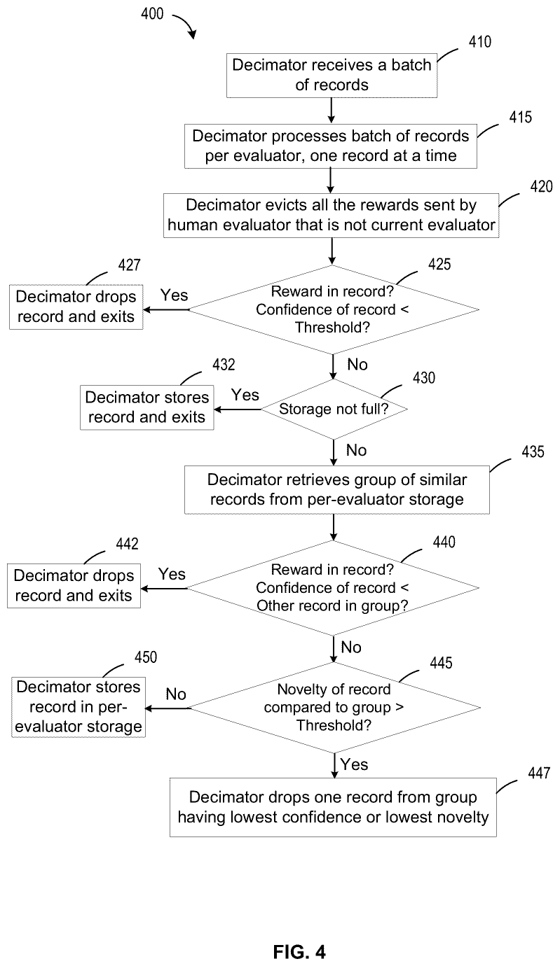

Referring now to FIG. 4, shown therein is a flowchart of an example embodiment of a method 400 of per-evaluator data decimation. The method 400 may be used by the system 100.

At 410, the decimator (e.g., the per-evaluator decimator 175) receives a batch of records (e.g., records 154).

At 415, the decimator begins processing the batch of records per evaluator (e.g., human evaluator 116), one record at a time.

At 420, the decimator evicts all the rewards that were sent by a human evaluator that is not the current evaluator.

At 425, the decimator determines if a reward is present in the record and if confidence of the record is lower than a given threshold. If Yes (i.e., a reward is present in the record and confidence of the record is lower than a given threshold), the method 400 proceeds to 427. If No (i.e., a reward is not present in the record or confidence is not lower than a given threshold), the method 400 proceeds to 430.

At 427, the decimator drops the record and exits.

At 430, the decimator determines if the available storage capacity of the record storage is equal to or above a capacity threshold (e.g., not full). If Yes (i.e., the available storage capacity of the record storage is equal to or above the capacity threshold), the method 400 proceeds to 432. If No (i.e., the available storage capacity of the record storage is below the capacity threshold), the method 400 proceeds to 435. In at least one implementation, the condition of the available storage capacity of the record storage being equal to or above the capacity threshold is met if the record storage has sufficient capacity to add at least a minimum amount of data (e.g., data sufficient to store the record).

At 432, the decimator stores the record (e.g., on the on-device storage 112) and exits.

At 435, the decimator retrieves a group of similar records from the per-evaluator storage (e.g., the on-device storage 112). Similar records may be, for example, records relating to the same learning session, records relating to the same portion of a particular learning session, records having a common state, records having a common action, or some combination thereof. Also, for example, similar records may be records that are “close” to the current record (e.g., using a k-nearest-neighbor data structure, such as the 10 closest ones); one valid but potentially impractical approach is to use all the stored records as this group.

At 440, the decimator determines if a reward is present in the record and if confidence of the record is lower than any other record in the group. If Yes (i.e., a reward is present in the record and confidence of the record is lower than any other record in the group), the method 400 proceeds to 442. If No (i.e., i.e., a reward is not present in the record or confidence of the record is not lower than any other record in the group), the method 400 proceeds to 445.

At 442, the decimator drops the record and exits.

At 445, the decimator determines if novelty of the record within the group is higher than a given threshold. If Yes (i.e., novelty of the record within the group is higher than a given threshold), the method 400 proceeds to 447. If No (i.e., novelty of the record within the group is not higher than a given threshold), the method 400 proceeds to 450.

At 447, the decimator drops one record from the group having the lowest confidence or the lowest novelty.

At 450, the decimator stores the record in the per-evaluator storage.

In at least one implementation, acts 425 to 450 happen locally on the device or in the storage backend based on the bandwidth objectives and constraints.

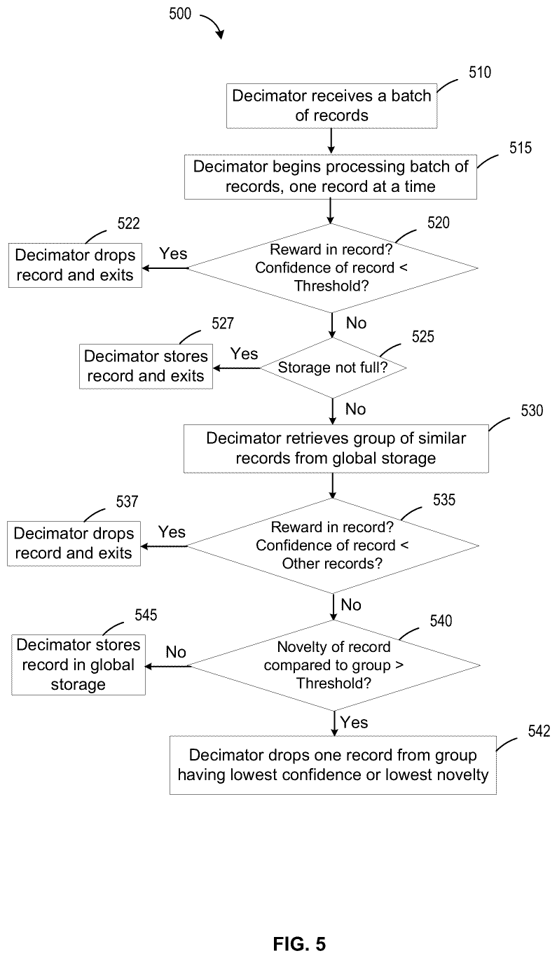

Referring now to FIG. 5, shown therein is a flowchart of an example embodiment of a method 500 of global population data decimation. The method 500 may be used by the system 100.

At 510, the decimator (e.g., the global decimator 170) receives a batch of records (e.g., records 152).

At 515, the decimator begins processing the batch of records, one record at a time.

At 520, the decimator determines if a reward is present in the record and if confidence of the record is lower than a given threshold. If Yes (i.e., a reward is present in the record and confidence of the record is lower than a given threshold), the method 500 proceeds to 522. If No (i.e., a reward is not present in the record or confidence of the record is not lower than a given threshold), the method 500 proceeds to 525.

At 522, the decimator drops the record and exits.

At 525, the decimator determines if the available storage capacity of the record storage is equal to or above a capacity threshold (e.g., not full). If Yes (i.e., the available storage capacity of the record storage is equal to or above the capacity threshold), the method 500 proceeds to 527. If No (i.e., the available storage capacity of the record storage is below the capacity threshold), the method 500 proceeds to 530. In at least one implementation, the condition of the available storage capacity of the record storage being equal to or above the capacity threshold is met if the record storage has sufficient capacity to add at least a minimum amount of data (e.g., data sufficient to store the record).

At 527, the decimator stores the record (e.g., in global storage 165) and exits.

At 530, the decimator retrieves a group of similar records from the global storage (e.g., global storage 165). Similar records may be, for example, records relating to the same learning session, records relating to the same portion of a particular learning session, records having a common state, records having a common action, or some combination thereof. Also, for example, similar records may be records that are “close” to the current record (e.g., using a k-nearest-neighbor data structure, such as the 10 closest ones); one valid but potentially impractical approach is to use all the stored records as this group.

At 535, the decimator determines if a reward is present in the record and if confidence of the record is lower than any other record in the group. If Yes (i.e., a reward is present in the record and confidence of the record is lower than any other record in the group), the method 500 proceeds to 537. If No (i.e., a reward is not present in the record or confidence of the record is not lower than any other record in the group), the method 500 proceeds to 540.

At 537, the decimator drops the record and exits.

At 540, the decimator determines if novelty of the record within the group is higher than a given threshold. If Yes (i.e., novelty of the record within the group is higher than a given threshold), the method 500 proceeds to 542. If No (i.e., novelty of the record within the group is not higher than a given threshold), the method 500 proceeds to 545.

At 542, the decimator drops one record from the group having the lowest confidence or the lowest novelty.

At 545, the decimator stores the record in the global storage.

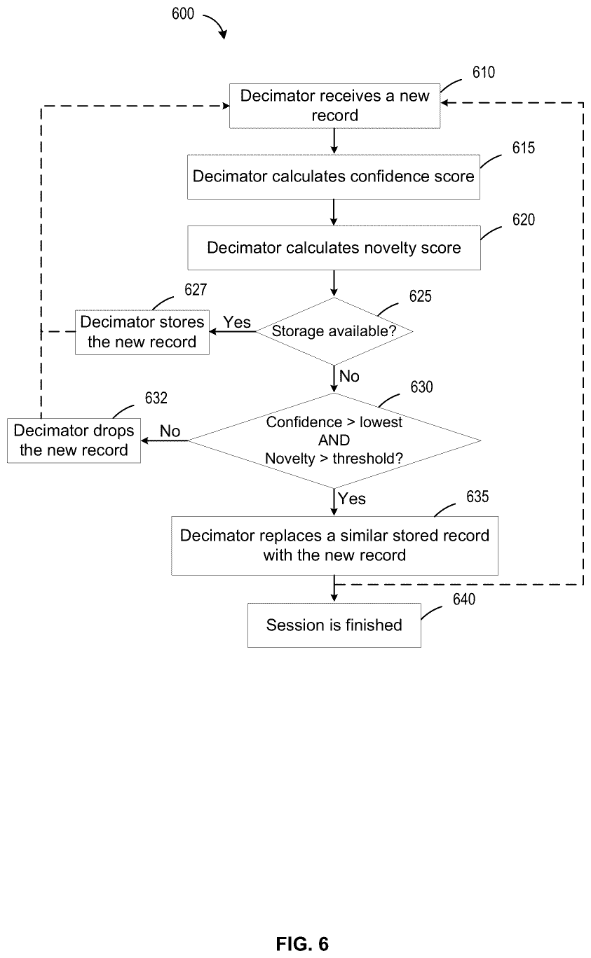

Referring now to FIG. 6, shown therein is a flowchart of an example embodiment of a method 600 of data decimation for one or more records. The method 500 may be used by the system 100. The method 600 may be considered a generalization of method 400, a generalization of method 500, or a combination of both method 400 and method 500. The method 600 may serve the purpose of managing the storage of reward records on a device of a human-in-the-loop learning system, where the device is, for example, the global decimator 170 or per-evaluator decimator 175.

At 610, a decimator (e.g., the global decimator 170, the per-evaluator decimator 175) receives a new record from a batch of records (e.g., records 152, records 154). The new record contains a state of an environment (e.g., simulation environment 135), an action taken by an agent (e.g., agent 140) in response to the state (e.g., state 124), and a reward (e.g., reward 122) generated by an evaluator (e.g., human evaluator 116). The new record may be a record that was generated, for example, by a single evaluator or any number of different evaluators.

At 615, the decimator calculates a confidence score for the new record. The confidence score for the new record may be (or based at least in part on) a likelihood that the reward contained in the new record was generated in response to the action contained in the new record. For example, the confidence score may be between 0 and 1, where a confidence score of 0 would represent no (or a negligible) chance that the reward was generated in response to the action, a confidence score of 1 would represent certainty (or near certainty) that the reward was generated in response to the action, and confidence scores in between 0 and 1 would represent a greater or lesser chance that the reward was generated in response to the action (e.g., greater when the confidence score is closer to 1 or lesser when the confidence score is closer to 0). For example, a confidence score with a higher magnitude (e.g., closer to 1) than for any other records may represent the situation where the action produced by an agent in response to observations formed by the agent resulted in a reward for that action being given by an evaluator (or multiple evaluators) having immediately identified that the agent's action had a higher impact on the environment or other agents than any other actions did. For example, suppose a model is trained on historical data to evaluate the co-occurrence of a type of action and a reward event; this co-occurrence factor can be used as a confidence score (e.g., when a left turn left and reward usually co-occur equates to a high score).

The confidence score may be calculated using one or more techniques, such as those applied to machine learning. For example, the confidence score may be calculated using the maximum class probability (e.g., largest softmax score) for the reward being associated with the action. Also, for example, the confidence score may be calculated using entropy as applied to the reward in connection with the action. Also, for example, the confidence score may be calculated using a margin as applied to the reward, such that the confidence score is based on the difference between the predicted probabilities of the first and second most probable classes of the reward being associated with the action.

At 620, the decimator calculates a novelty score for the new record. The novelty score for the new record may be (or based at least in part on) similarities between the new record and a plurality of similar stored records contained on a record storage (e.g., global storage 165) of the device. Each of the plurality of similar stored records has an associated confidence score and novelty score. The plurality of similar stored records may be, for example, records relating to the same learning session, records relating to the same portion of a particular learning session, records having a common state, records having a common action, or some combination thereof.

At 625, the decimator determines if the available storage capacity of the record storage is equal to or above a capacity threshold (e.g., not full). If Yes (i.e., the available storage capacity of the record storage is equal to or above the capacity threshold), the method 600 proceeds to 627. If No (i.e., the available storage capacity of the record storage is below the capacity threshold), the method 600 proceeds to 630. In at least one implementation, the condition of the available storage capacity of the record storage being equal to or above the capacity threshold is met if the record storage has sufficient capacity to add at least a minimum amount of data (e.g., data sufficient to store the record).

At 627, the decimator stores the new record and exits. The method 600 may end here, or the method 600 may return to 610 to process another record from the batch of records.

At 630, the decimator determines that: (a) the confidence score of the new record is above the lowest confidence score associated with any of the plurality of similar stored records; and (b) the novelty score of the new record is above a novelty threshold based on the novelty scores of the plurality of similar stored records. The novelty threshold may be, for example, the mean novelty score, some fraction of the mean novelty score (e.g., ⅓ or ½ of the mean novelty score), the median novelty score, some fraction of the median novelty score (e.g., ⅓ or ½ of the median novelty score), some fraction of the maximum novelty score possible (e.g., ⅓ or ½ of the maximum novelty score possible), some fraction of the maximum novelty score to date (e.g., ⅓ or ½ of the maximum novelty score to date), etc. If Yes (i.e., both conditions (a) and (b) are met), the method 600 proceeds to 622. If No (i.e., a both conditions (a) and (b) are not met), the method 600 proceeds to 625.

In at least one implementation, at 630, the decimator may also determine that: (c) a reward is present in the record. Where the decimator makes this additional determination, the method 600 proceeds to 635 if all of conditions (a), (b), and (c) are met, and the method 600 proceeds to 632 if not all of conditions (a), (b), and (c) are met.

At 632, the decimator drops the new record and exits. The method 600 may end here, or the method 600 may return to 610 to process another record from the batch of records.

At 635, the decimator replaces one of the plurality of similar stored records in the record storage with the new record. The one of the plurality of similar stored records being replaced may be, for example, the one having the lowest confidence score or the one having the lowest novelty score. The method 600 may end here, or the method 600 may return to 610 to process another record from the batch of records.

At 640, the session is finished and the method 600 is complete. The session may be finished by, for example, the decimator reaching the last record from the batch of records. Also, for example, the session may be finished if an instruction has been sent to the decimator to discontinue processing new records.

In at least one embodiment, the method 600 is repeated for a plurality of new records, each new record being received from a specific evaluator. In this embodiment, the device is a local networked device forming part of the human-in-the-loop learning system and is associated with the specific evaluator. The device may be, for example, the per-evaluator decimator 175.

In at least one embodiment, the method 600 is repeated for a plurality of new records being associated with a plurality of evaluators. In this embodiment, the device is a storage backend of the human-in-the-loop learning system. The device may be, for example, the global decimator 170.

The methods of data decimation (e.g., method 400, method 500, method 600) can achieve the goal of storing data of high quality, based on the data being highly correlated and not repeated (i.e., novel). A subgoal is to streamline storage by the system keeping only what is the most valuable without repetition.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A computer-implemented method for managing storage of reward records on a device of a human-in-the-loop learning system, the method comprising:
receiving a new record, the new record containing a state of an environment, an action taken by an agent in response to the state, and a reward generated by an evaluator;
calculating a confidence score for the new record based at least in part on a likelihood that the reward contained in the new record was generated in response to the action contained in the new record;
calculating a novelty score for the new record based at least in part on similarities between the new record and a plurality of similar stored records contained on a record storage of the device, each of the plurality of similar stored records having an associated confidence score and an associated novelty score;
determining whether an available storage capacity of the record storage is above a capacity threshold;
storing the new record in the record storage of the device if the available storage capacity of the record storage is equal to or above the capacity threshold; and
replacing one of the plurality of similar stored records in the record storage with the new record if the available storage capacity of the record storage is below the capacity threshold, the confidence score of the new record is above the lowest confidence score associated with any of the plurality of similar stored records, and the novelty score of the new record is above a novelty threshold based on the novelty scores of the plurality of similar stored records.

2. The computer-implemented method of claim 1, wherein the method is repeated for a plurality of new records, each new record being received from a specific evaluator, and wherein the device is a local networked device forming part of the human-in-the-loop learning system and being associated with the specific evaluator.

3. The computer-implemented method of claim 1, wherein the method is repeated for a plurality of new records being associated with a plurality of evaluators, and wherein the device is a storage backend of the human-in-the-loop learning system.

4. The computer-implemented method of claim 1, wherein replacing one of the plurality of similar stored records further comprises replacing one of the plurality of similar stored records having the lowest confidence score.

5. The computer-implemented method of claim 1, wherein replacing one of the plurality of similar stored records further comprises replacing one of the plurality of similar stored records having the lowest novelty score.

6. The computer-implemented method of claim 1, wherein the confidence score is calculated using at least one of a co-occurrence of the reward contained in the new record and the action contained in the new record, a maximum class probability for the reward contained in the new record, a negative entropy of the reward contained in the new record, or a margin for the reward contained in the new record.

7. The computer-implemented method of claim 1, wherein the novelty score is calculated using at least one of a z-score for the new record compared to the plurality of similar stored records; an anomaly score for the new record using an isolation forest comprising the plurality of similar stored records, or a one-class SVM for the new record in relation to the plurality of similar stored records.

8. The computer-implemented method of claim 1, wherein the novelty threshold is calculated by at least one of a mean of previous novelty scores, some fraction of the mean of previous novelty score, the median of previous novelty score, some fraction of the median of previous novelty scores, some fraction of the maximum novelty score possible, or some fraction of the maximum novelty score to date.

9. The computer-implemented method of claim 1, wherein the similar stored records relate to a same portion of a learning session, records having a common state, records having a common action, or some combination thereof.

10. The computer-implemented method of claim 1, wherein the similar stored records relate to one another by at least one of a common state or a common action.

11. A system for managing storage of reward records on a device of a human-in-the-loop learning system, the system comprising:
a processor; and
a non-transitory computer-readable medium having store thereon instructions which when executed by the processor cause the device to:
i) receive a new record, the new record containing a state of an environment, an action taken by an agent in response to the state, and a reward generated by an evaluator;
ii) calculate a confidence score for the new record based at least in part on a likelihood that the reward contained in the new record was generated in response to the action contained in the new record;
iii) calculate a novelty score for the new record based at least in part on similarities between the new record and a plurality of similar stored records contained on a record storage of the device, each of the plurality of similar stored records having an associated confidence score and an associated novelty score;
iv) determine whether an available storage capacity of the record storage is above a capacity threshold;
v) store the new record in the record storage of the device if the available storage capacity of the record storage is equal to or above the capacity threshold; and
vi) replace one of the plurality of similar stored records in the record storage with the new record if the available storage capacity of the record storage is below the capacity threshold, the confidence score of the new record is above the lowest confidence score associated with any of the plurality of similar stored records, and the novelty score of the new record is above a novelty threshold based on the novelty scores of the plurality of similar stored records.

12. The system of claim 11, wherein the device is further caused to repeat steps i) to vi) for a plurality of new records, each new record being received from a specific evaluator, and wherein the device is a local networked device forming part of the human-in-the-loop learning system and being associated with the specific evaluator.

13. The system of claim 12, wherein the device is further caused to repeat steps i) to vi) for a plurality of new records being associated with a plurality of evaluators, and wherein the device is a storage backend of the human-in-the-loop learning system.

14. The system of claim 11, wherein when the device is caused to replace one of the plurality of similar stored records, the device is further caused to replace one of the plurality of similar stored records having the lowest confidence score.

15. The system of claim 11, wherein when the device is caused to replace one of the plurality of similar stored records, the device is further caused to replace one of the plurality of similar stored records having the lowest novelty score.

16. The system of claim 11, wherein the confidence score is calculated using at least one of a co-occurrence of the reward contained in the new record and the action contained in the new record, a maximum class probability for the reward contained in the new record, a negative entropy of the reward contained in the new record, or a margin for the reward contained in the new record.

17. The system of claim 11, wherein the novelty score is calculated using at least one of a z-score for the new record compared to the plurality of similar stored records; an anomaly score for the new record using an isolation forest comprising the plurality of similar stored records, or a one-class SVM for the new record in relation to the plurality of similar stored records.

18. The system of claim 11, wherein the novelty threshold is calculated by at least one of a mean of previous novelty scores, some fraction of the mean of previous novelty score, the median of previous novelty score, some fraction of the median of previous novelty scores, some fraction of the maximum novelty score possible, or some fraction of the maximum novelty score to date.

19. The system of claim 11, wherein the similar stored records relate to a same portion of a learning session, records having a common state, records having a common action, or some combination thereof.

20. The system of claim 11, wherein the similar stored records relate to one another by at least one of a common state or a common action.
